(19) United States
(12) Patent Application Publication
(10) Pub. No.: US 2005/0031661 A1
(43) Pub. Date: Feb. 10, 2005

(54) Attractants for moths

(76) Inventors: Peter J. Landolt, Yakima, WA (US); Connie L. Smithhisler, Yakima, WA (US)

Correspondence Address: USDA-ARS-OFFICE OF TECHNOLOGY TRANSFER;PATENT ADVISORS OFFICE, WESTERN REGIONAL RESEARCH CENTER, 800 BUCHANAN ST, ALBANY, CA, 94710, US

(21) Appl. No.: 10/637,922

(22) Filed: Aug. 8, 2003

(51) Int. Cl. A01N 27/00

(52) U.S. Cl. 424/405

(57) ABSTRACT

Compositions and lures are described which provide synthetic chemical attractants which function as highly effective attractants for male, female, or male and female moths, primarily moths of the family Noctuidae. In one aspect, the attractants provide an effective attractant amount of β-myrcene and phenylacetaldehyde or benzyl acetate. In another aspect, the attractants provide an effective attractant amount of phenylacetaldehyde and methyl-2-methoxybenzoate, but do not include methyl salicylate. By attracting moths to traps or baits, the chemical attractants provide a means for detecting, surveying, monitoring, and controlling lepidopteran pests.

### BACKGROUND OF THE INVENTION

1. Field of the Invention

The present invention relates to synthetic chemical insect attractants. More particularly, the invention relates to synthetic attractants and use thereof to detect, survey, monitor, and/or control insects, including alfalfa loopers, corn earworms, cabbage loopers, and other species of Lepidoptera.

2. Description of the Art

100021 Many insects of the order Lepidoptera are pestiferous and are responsible for substantial crop losses and reduced crop quality worldwide. Examples of Lepidoptera in the family Noctuidae that are responsible for substantial crop losses include loopers, earworms, and fruitworms. The alfalfa looper Autographa californica (Speyer) (Lepidoptera: Noctuidae) is a widespread and general pest of numerous crops throughout western North America, including alfalfa, vegetable crops, and ornamentals. It is a close relative of both the gamma moth and the cabbage looper and is a highly polyphagous caterpillar. Larvae feed on crop leaves causing holes in the leaf and on leaf margins. Larvae and pupae also cause defoliation of crop plants. The corn earworm Helicoverpa zea (Boddie) (Lepidoptera: Noctuidae) is widely distributed throughout North, Central, and South America and is a major pest of corn, cotton, and tomato. Other host plants include beans, eggplant, cabbage, fruits, peas, peppers, ornamentals, squash, and strawberries. Damage is caused by larvae feeding on or burrowing into host plants. The cabbage looper Trichoplusia ni (Hübner) (Lepidoptera: Noctuidae) causes crop damage throughout North America.

There is increasing regulatory pressure to decrease the use of broadcast applications of pesticides on agricultural crops to control pest moth populations. Chemical attractants are widely used to monitor the emergence patterns and distributions of moths on crops. These are primarily sex pheromones attractive solely to males. They are of limited use in pest control because of the lack of effect on females and because they are not effective as attractants when the same sex pheromones are used for mating disruption by air permeation. The development of chemical attractants for monitoring pest levels and economic injury levels of pest moths on crops has been hampered by a lack of effective lures for females of these species. Similarly, the development of control technologies involving mass trapping of moths or poison baits would be greatly facilitated by the availability of effective lures for females of pest species.

Attraction of insects to flower volatiles has been reported. Several pest species of Noctuidae in the subfamilies Plusiinae and Heliothinae are common visitors at flowers of certain species of plants (Grant, Journal of Economic Entomology 64: 315-316, 1971), and are attracted by volatile chemicals released by flowers of those plants (Cantelo and Jacobson, Environmental Entomology 8: 444-447, 1979a; Beerwinkle et al., Southwestern Entomologist 21:395-405, 1996; Haynes et al., Journal of Chemical Ecology 17: 637-646, 1991; Heath et al., Environmental Entomology 21: 854-859, 1992). Volatile chemicals emitted by some of these flowers have been characterized; Gaura drummondii (Spach.) (Teranishi et al., J. Ess. Oil Research 3: 287-288, 1991), Abelia grandiflora (Andre) (Haynes et al., 1991, supra), Cestrum nocturnum L. (Heath et al., Environmental Entomology 21: 854-859, 1992), Araujia sericofera Brot. (Cantelo and Jacobson, 1979a, supra), Lonicera japonica (Schlotzhauer et al., Journal of Agric. and Food Chemistry, 44: 206-209, 1996). The cabbage looper Trichoplusia ni (Hübner), the soybean looper Pseudoplusia includens (Walker), the alfalfa looper Autographa californica (Speyer), and other Lepidoptera are attracted to synthetic versions of these chemicals emitted by these flowers (Cantelo and Jacobson, 1979a, supra; Haynes et al., 1991, supra; Landolt et al., Journal of Economic Entomology 84: 1344-1347, 1991; Landolt et al., Environmental Entomology 30: 667-672, 2001; Heath et al., Environmental Entomology 21: 854-859, 1992; U.S. Pat. No. 5,665,344 to Pair and Horvat, 1997).

Feeding attractants such as these floral compounds are attractive to both sexes of several pest species of Lepidoptera and might be useful both as a means of monitoring pest populations and as part of lure and kill systems for pest population control (Landolt et al. 1991, supra; U.S. Pat. No. 5,665,344 to Pair and Horvat, 1997; U.S. Pat. No. 6,074,634 to Lopez et al., 2000). Phenylacetaldehyde has been reported to attract corn earworm moths (Cantelo and Jacobson, J. Environ. Sci. and Health A14: 695-707, 1979b). This compound is present in several flowers visited by corn earworm, such as bladderflower (Cantelo and Jacobson, 1979a, supra), Gaura drummondii (Teranishi et al., 1991, supra), and Japanese honeysuckle (Schlotzhauer et al., 1996, supra), and is present in corn silk on which female moths oviposit (Cantelo and Jacobson 1979b). Methyl-2-methoxybenzoate is present in the volatiles of Gaura drummondii flowers (Teranishi et al., 1991, supra). Both of these compounds are present in the 5-component blend found to be attractive by Lopez et al., 2000 (U.S. Pat. No. 6,074,634). Seven compounds reported as volatiles from moth-visited plants were evaluated for their attractiveness to the alfalfa looper moth (Landolt et al., 2001, supra). In that study, alfalfa looper moths were attracted to phenylacetaldehyde and to benzyl acetate, as was indicated by their capture in traps baited with these chemicals, but were not attracted to 2-phenylethanol, benzyl alcohol, benzaldehyde, cis-jasmone, or linalool. U.S. Pat. No. 5,665,344 to Pair and Horvat reports that volatiles from the flowers of the Japanese honeysuckle which included cis-jasmone, alone or in combination with linalool and/or phenylacetaldehyde, attracted adult Lepidoptera. U.S. Pat. No. 6,074,634 to Lopez et al. reports that adult noctuid or other lepidopteran species were attracted to a mixture of 20-45% by weight phenylacetaldehyde, 0-30% by weight 2-phenylethanol, 0-30% by weight limonene, 15-40% by weight methyl-2-methoxybenzoate, and 5-25% by weight methyl salicylate. U.S. Pat. Nos. 6,264,939 and 6,528,049 to Light et al. report purified volatile bisexual attractants for adult insect and larvae of lepidopterous species wherein the attractants include ethyl (2E,4Z)-2,4-decadienoate in admixture with selected other 2,4-decadienoate esters.

### SUMMARY OF THE INVENTION

The present invention is directed to chemical attractants and use thereof for attracting economically important species of Lepidoptera, particularly in the family Noctuidae. The attractants are useful for attracting male, female or male and female moths to lures containing the attractants and provide a means for detecting, surveying, monitoring, and controlling these pests.

In one embodiment, the invention is directed to a composition for attracting noctuid moths and other lepidopteran species comprising an attractant component which comprises (I) β-myrcene and (II) one or more compounds selected from the group consisting of phenylacetaldehyde and benzyl acetate. The attractant composition provides volatilized blends of I and II in an amount effective to attract moths. In one aspect, the volatilized blend of the attractant combination is provided by a mixture of I and II. In another aspect, the vapor blend is provided by a combination of I and II wherein I and II are placed in separate dispensers and the dispensers are positioned in sufficient proximity to one another to form an effective moth attractant volatilized blend.

In another embodiment, the invention is directed to a composition for attracting noctuid moths and other lepidopteran species comprising an attractant component which comprises phenylacetaldehyde and methyl-2-methoxybenzoate, and wherein the composition does not include methyl salicylate. The attractant composition provides volatilized blends of the compounds in an amount effective to attract moths. In one aspect, the volatilized blend of the attractant combination is provided by a mixture of the compounds. In another aspect, the vapor blend is provided by separate dispensers containing phenylacetaldehyde and methyl-2-methoxybenzoate, wherein the dispensers are positioned in sufficient proximity to one another to form an effective moth attractant volatilized blend.

Many species of noctuid moths are key pests of agricultural crops and cause losses of vegetable, fruit, forage, and fiber crops through direct consumption by larvae and by reduction in food quality. The attractants of the invention are useful to remove such moths in areas where they are reproducing and causing damage to crops and commodities. The chemical attractants of the invention provide a means of reducing populations of pestiferous species over defined areas by mass trapping and alleviate threats of losses to agricultural crops. Further, when used in combination with a control agent for the moths, the chemical attractants can be used as direct control agents.

The attractants of the invention can also be used as a poisoned bait by combining them with feeding stimulants and toxicants that the moths ingest, effectively killing or sterilizing them.

In sum, the chemical attractants of the invention provide a tool for the detection of noctuid moth species and provide a means for population control and population density estimation of these pests. The lures and trapping systems which include the attractants of the invention are useful for farmers and growers, orchardists, homeowners and gardeners, and other users where control of pest noctuid moths is desired.

The utility and effectiveness of the invention in attracting noctuid moths suggests the following applications: (1) the detection of populations, (2) the detection of population outbreaks or rapid population buildups, (3) the monitoring of populations, (4) the control of problem populations in discrete areas. In certain geographic areas there is a need to detect the presence of certain species of pest moths as they move into new areas, so that these populations may be destroyed or controlled. Such outbreaks can be detected by programs to attract and trap moths, thereby gaining information on changes in moth numbers. It is expected that a means of sampling females in addition or males of a species will provide valuable information more closely related to pest activity and reproduction at a site. The attractants of the invention are also useful as a bait for traps used to monitor changes in population level. For example, efficacy of control procedures such as pesticide or microbial applications, may be measured with attractant traps that indicate population levels. Again, it is expected that a means of sampling females rather than exclusively males will provide more useful information in relation to the population of a pest at a discrete site. The attractants are also useful to control moth populations and activities where they are a problem through a variety of approaches, including localized trapping out of moths, and the use of the attractant in a poison bait formulation to kill attracted moths.

In accordance with this discovery, it is an object of the invention to provide chemical attractants for male, female or male and female moths, particularly noctuid moths.

Another object of the invention is the provision of the attractants as detection, surveying, monitoring, or control agents for moths.

A further object of the invention is the provision of the attractants of the invention for use with control agents, including drowning solutions, insecticides, biological control agents, or other toxicants, to attract and combat these pests.

A still further object of the invention is the provision of trapping systems for trapping pest moths which include trapping means and an effective attractant amount of the attractants of the invention.

Other objects and advantages of the invention will become readily apparent from the ensuing description.

### BRIEF DESCRIPTION OF THE DRAWINGS

FIG. 1 shows a typical chromatogram from analysis of volatile collection described in Example 1 made over flowers of Oregongrapee, using a DB wax capillary column. Peaks: (a) α-pinene, (b) β-pinene, (c) sabinene, (d) β-myrcene, (e) limonene, (f) E-β-ocimene, (g) benzaldehyde, and (h) phenylacetaldehyde.

FIG. 2 shows the structures of compounds isolated and identified from volatile collections made over open flowers of Oregongrapee as described in Example 1.

### DETAILED DESCRIPTION OF THE INVENTION

The present invention is directed to chemical attractants and use thereof effective for attracting economically important species of Lepidoptera, particularly in the family Noctuidae, and more particularly in the subfamilies Plusiinae, Heliothinae, and Cuculliinae, and in the families Pyralidae and Sphingidae. The attractants are useful for attracting male, female or male and female moths to lures containing the attractants and provide a means for detecting, surveying, monitoring, and controlling these pests.

In one embodiment, the invention is directed to attracting noctuid moths and other lepidopteran species using a composition which comprises an attractant component which comprises (I) β-myrcene and (II) one or more compounds selected from the group consisting of phenylacetaldehyde and benzyl acetate. These findings were unexpected and surprising because β-myrcene alone showed no significant attractant response from cabbage looper moths (see Example 2, Table 3, below) or corn earworm moths (see Example 3, Table 8, below) and showed only a very weak attractant response by alfalfa looper moths (see Example 2, Table 3, below). Additionally, a blend of monoterpenes (walnut-based) containing β-myrcene has been reported as non-attractive to moths (see U.S. Pat. No. 6,264,939, Table 3, #21). Moreover, while phenylacetaldehyde was known to be attractive to noctuid moths, when β-myrcene was provided in combination with phenylacetaldehyde, the combination is significantly more attractive to the moths (see Example 2, Tables 4-5, and Example 3, Table 9, below). When β-myrcene was provided in combination with benzyl acetate, significantly more alfalfa looper moths were captured. This is the first demonstration of moth attraction to β-myrcene. Further as noted above, β-myrcene was also shown to increase catches of alfalfa looper moths when presented with phenylacetaldehyde or with benzyl acetate. Seasonal monitoring of alfalfa looper moths indicated that traps baited with phenylacetaldehyde and β-myrcene attracted both male and female moths.

The synthetic attractant composition of the invention provides volatilized blends of the compounds. In one aspect, the volatilized blend of the attractant combination is provided by a mixture of I and II (data not shown). In another aspect, the vapor blend is provided by a combination of I and II wherein separate dispensers of I and II are positioned in sufficient proximity to each other effective to form a volatilized blend of I and II (see Examples 2-4, below).

For purposes of this invention the terms blends and mixtures are used to mean combinations of I and II. Attracted moths respond to the combination of odorants from 1 and II present simultaneously in air and they move upwind towards the source of the blend. An effective amount of an attractant vapor blend of I and II is defined as that quantity of the chemical blend that attracts moths to the location of the blend at a rate higher than moths are attracted to a location devoid of the blend. An effective attractant amount is determined as the quantities of the compounds emitted from a formulation or dispenser holding the compounds that is sufficient to elicit attraction response from moths downwind of the attractant vapor blend or mixture.

Exemplary formulations include β-myrene:phenylacetaldehyde (I:II) or β-myrcene:benzyl acetate (I:II) loaded in a ratio range of I:II of about 0.1:1 to 1:0.1, preferably in a ratio range of about 0.5:1 to 1:0.5, more preferably in a ratio range of about 1:1 to 1:3 and even more preferably in a ratio of about 1:1.

Effective odorant amounts of β-myrcene (I) or phenylacetaldehyde or benzyl acetate (II) released as a vapor into air are most readily defined as weight amounts released per unit time from a formulation, dispenser, bait or trap. The broad range of release rates is that which is an effective attractant for the target moth. An effective release rate range for β-myrcene is from about 1 μg per hour to about 1 milligram per hour. A preferred release rate range of β-myrcene is from about 100 μg per hour to 1 mg per hour. An effective release range for phenylacetaldehyde or benzyl acetate is about 3 μg per hour to about 5 milligram per hour. A preferred release rate range is about is about 100 μg per hour to 1 mg per hour.

Controlled release of the compounds may also be effected in part through the addition of an extender such as mineral oil, which will reduce the rate of volatilization of the odorants out of a dispenser.

Factors such as moth species present, moth population density, and environmental factors influencing moth foraging behavior (e.g., temperature, wind velocity, rain, time of day and seasonality) will influence the response of moths to the attractants of the invention and the actual number of moths attracted. The amounts of compound or compounds in a particular set of circumstances that will provide release rates within an effective range can be readily determined by dose response field tests as described in the Examples, below.

Other compounds and materials may be added to a formulation, lure, bait or trap provided they do not substantially interfere with the attractancy of the attractant vapor composition of the invention. Whether or not an additive substantially interferes with the attractant activity can be determined by standard test formats, involving direct comparisons of efficacy of the attractant without an added compound and the attractant with an added compound. Reductions in attractancy, such as reduced captures of moths in traps baited with the attractant with the additive, may be determined with standard statistical analyses. As shown in the Examples, below, numbers of alfalfa looper moths in traps baited with the combination of phenylacetaldehyde plus β-myrcene plus methyl-2-methoxybenzoate were similar to numbers captured in traps baited with phenylacetaldehyde plus β-myrcene (see Example 2, Table 5). The numbers of alfalfa looper moths captured with the 3-component blend of phenylacetaldehyde, cis-jasmone, and β-myrcene were not significantly greater than with the combination of phenylacetaldehyde plus β-myrcene (see Example 2, Table 6). The numbers of cabbage looper moths captured with the combination of phenylacetaldehyde and β-myrcene were not significantly different from the numbers captured with the 3-component blend of phenylacetaldehyde, β-myrcene and linalool (see Example 2, Table 5). In contrast, the addition of linalool to the phenylacetaldehyde and β-myrcene combination decreased the attractancy of the phenylacetaldehyde and β-myrcene combination for alfalfa looper moths (see Example 2, Table 5).

In another embodiment, the invention is directed to attracting noctuid moths and other lepidopteran species using a composition which comprises an attractant component which comprises phenylacetaldehyde and methyl-2-methoxybenzoate, and wherein the composition does not include methyl salicylate. These findings were unexpected and surprising because this is the first demonstration of moth attraction to methyl-2-methoxybenzoate alone (see Example 2, Table 3 for cabbage looper moths and Example 3, Table 8 for corn earworm moths). Moreover, Lopez et al. (U.S. Pat. No. 6,074,634) report that to have moth attractancy, the presence of 5-25% by weight of methyl salicylate is required in combination with phenylacetaldehyde and methyl-2-methoxybenzoate. Surprisingly, we found the composition comprising phenylacetaldehyde and methyl-2-methoxybenzoate without methyl salicylate was a highly effective attractant for corn earworm moths (see Example 3, Table 9, below). Seasonal monitoring of corn earworm moths indicated that traps baited with phenylacetaldehyde and methyl-2-methoxybenzoate without methyl salicylate attracted both male and female moths in roughly equal numbers. In contrast, traps baited with corn earworm pheromone captured male moths.

The attractant composition provides volatilized blends of the compounds in an amount effective to attract moths. In one aspect, the volatilized blend of the attractant combination is provided by a mixture of the compounds (data not shown). In another aspect, the vapor blend is provided by separate dispensers containing phenylacetaldehyde and methyl-2-methoxybenzoate, wherein the dispensers are positioned in sufficient proximity to one another to form an effective moth attractant volatilized blend (see Examples 2-4, below).

For purposes of this invention the terms blends and mixtures are used to mean combinations of phenylacetaldehyde and methyl-2-methoxybenzoate. Attracted moths respond to the combination of odorants from phenylacetaldehyde and methyl-2-methoxybenzoate present simultaneously in air and they move upwind towards the source of the blend. An effective amount of an attractant vapor blend of phenylacetaldehyde and methyl-2-methoxybenzoate is defined as that quantity of the chemical blend that attracts moths to the location of the blend at a rate higher than moths are attracted to a location devoid of the blend. An effective attractant amount is determined as the quantities of the compounds emitted from a formulation or dispenser holding the compounds that is sufficient to elicit attraction response from moths downwind of the attractant vapor blend or mixture.

Exemplary formulations include phenylacetaldehyde:methyl-2-methoxybenzoate in a ratio range of about 0.1:1 to about 1:0.1, preferably in a ratio range of about 0.5:1 to 1:0.5, more preferably in a ratio range of about 1:1 to 3:1 and even more preferably in a ratio of about 1:1.

Effective odorant amounts of phenylacetaldehyde or methyl-2-methoxybenzoate released as a vapor into air are most readily defined as weight amounts released per unit time from a formulation, dispenser, bait or trap. The broad range of release rates is that which is an effective attractant for the target moth. An effective release range for phenylacetaldehyde is about 30 μg per hour to about 1 milligram per hour. A preferred release rate range is about is about 100 μg per hour to 1 mg per hour. An effective release rate range for methyl-2-methoxybenzoate is from about 1.0 μg per hour to about 1 milligram per hour. A preferred release rate range of β-myrcene is from about 10 μg per hour to 1 mg per hour.

Controlled release of the compounds may also be effected in part through the addition of an extender such as mineral oil, which will reduce the rate of volatilization of the odorants out of the dispenser.

Factors such as moth species present, moth population density, and environmental factors influencing moth foraging behavior (e.g., temperature, wind velocity, rain, time of day and seasonality) will influence the response of moths to the attractants of the invention and the actual number of moths attracted. The amounts of compound or compounds in a particular set of circumstances that will provide release rates within an effective range can be readily determined by dose response field tests as described in the Examples, below.

Other compounds and materials may be added to a formulation, lure, bait or trap provided they do not substantially interfere with the attractancy of the attractant vapor composition of the invention. Whether or not an additive substantially interferes with the attractant activity can be determined by standard test formats, involving direct comparisons of efficacy of the attractant without an added compound and the attractant with an added compound. Reductions in attractancy, such as reduced captures of moths in traps baited with the attractant with the additive, may be determined with standard statistical analyses.

Lures. It is envisioned that the chemical attractants of the invention would be useful in detecting, surveying, monitoring, or controlling noctuid moth populations when used as a lure. A lure includes a dispenser means which contains a chemical or chemicals which provide the attractant. For purposes of this invention, a dispenser means is defined as any means which both (a) contains or holds the unvolatilized compound or compounds used to produce the vapor of the attractant and (a) releases the compound or compounds in the vapor phase.

A dispensing means may take several forms, wherein a formulation to produce the volatilized compounds or mixture is contained for release into a selected area where moths may occur. Dispensing means include an adsorbent material such as cotton or paper which both holds and releases a compound or mixture. In general, however, a dispensing means will comprise a reservoir for holding an amount of a compound either within a space or a polymeric matrix, with the release into the atmosphere controlled by a permeable wall or membrane or by a small opening surrounded by an impermeable wall or membrane. Examples of dispensers include a reservoir and polyethylene cap within a trap as described the Examples, below. Further examples of dispensers include polymer caps, bubbles, hollow fibers, hollow tubes or tubing which release compounds through the walls, capillary tubing which release compounds out of an opening in the tubing, polymeric blocks of different shapes which release compounds out of the polymer matrix, membrane systems which hold the chemicals within an impermeable container and release them through a measured permeable membrane, and combinations of the foregoing. Examples of other dispensing means are polymer laminates, polyvinyl chloride pellets, microcapillaries, and Shunitzu rope. Another dispensing means includes using microencapsulation techniques to encapsulate each compound used to produce the vaporized compound, mixture or vapor blend.

In one aspect of the invention, the individual compounds that provide the attractant composition may be formulation as a mixture in a dispenser to produce the volatilized attractant blend of the attractant combination. In another aspect, individual compounds that provide the attractant composition are provided in separate dispensers, e.g., a first and second dispenser, which are positioned in sufficient proximity to one another to provide an effective moth attractant volatilized blend in the surrounding atmosphere. The first and second dispensers may optionally be attached or fused to form one device or unit that releases the compounds to form the vapor blend. Alternatively, the individual compounds may be formulated in separate dispensers, for example, placing in individual vials as described in the Examples, below.

Optionally, the compositions or lures of the invention may be further formulated with other insect attractants such as pheromones of the target insects or insect extracts containing pheromones, or with conventional feeding stimulants such as saccharides. Lepidopteran pheromones suitable for use herein are generally well-known in the art. Overviews of the pheromones for many insects, including many Lepidoptera, have been described, and include, for example, Mayer and McLaughlin (Handbook of Insect Pheromones and Sex Attractants, CRC Press, Boca Raton, Fla., 1991) and Tamaki [Sex Pheromones, In Comprehensive Insect Physiology Biochemistry and Pharmacology, Vol. 9 Behavior, Kerkut and Gilbert (Ed.), Pergamon Press, New York, pp. 145-179]. The lures may also be combined with feeding stimulants to provide baits for moths, particularly pestiferous noctuid species. Toxicants may also be added to provide poisoned baits, as discussed in detail below.

Trapping Systems. The attractants of the invention may be used as detecting agents, surveying agents, monitoring agents, or control agents for the moths. The attractant may be placed within a trap which allows the insects to enter but prevents their exit. In this manner, the foraging power of the colony is reduced thereby achieving some degree of control over the colony. A trapping system for monitoring or controlling moths includes a trapping means, and a dispenser means located within the trapping means which provides an effective attractant amount of the attractants of the invention. In a first embodiment the attractant composition provides a vapor blend comprising vapor of (I) β-myrcene and vapor of (II) one or more compounds selected from the group consisting of phenylacetaldehyde and benzyl acetate. In a second embodiment the attractant composition provides a vapor blend comprising vapor of phenylacetaldehyde and vapor of methyl-2-methoxybenzoate, and wherein the second embodiment does not include methyl salicylate. The dispenser provides an effective moth attractant amount of said vapor blend.

A trapping means is any device for catching insects, particularly, noctuid moths. These include for example, the Trappit dome trap by Agrisense, LIQUIDATOR Trap by Phero Tech Inc., Yellow Jacket Wasp Trap by Oak Stump Farm (U.S. Pat. No. 4,794,724), the Pherocon trap by Zoecon, Inc., and the Universal moth trap or UniTrap®.

A preferred trap for the combination attractant of the invention is one which has a mixing chamber wherein vapors of the attractant component form a blend and the vapor blend exits the trap chamber and attracts moths to the chamber where they are trapped. Compounds that produce the attractant vapor blend may be presented as a mixture or in separate dispensers within the trap. A drowning solution may be used in a trap, and the attractant blend can be formulated to emanate from the drowning solution. The drowning solution may optionally contain additional materials that aid in the capture and killing of attracted moths, such as detergents or wetting agents, clays, dyes and toxicant, as long as such additives do not substantially interfere with the attractiveness of the attractant blend of the invention. For dry traps, in which attracted moths are killed by toxicant or insolation, other formulation methods may be used as known in the art.

Means for Controlling Moths. The attractants of the invention are useful for control of noctuid moths or other lepidopteran species when used in concert with means for controlling moths. Control of moths may be carried out as known in the art, including (a) by capturing the moths in traps, (b) by capturing moths in a trap and killing the moths, for example, by means of a drowning solution or pesticide for moths, or (c) by use of toxicants, pesticides or chemosterilants, (d) by use of poisoned bait, e.g., the combination of a feeding stimulant and toxicant, or (e) by use of pathogens, for example, by bringing the attracted moths into contact with pathogens or by incorporating pathogens.

Insecticides or toxicants for moths include compounds such as methomyl, dimethyl (2,2,2-trichloro-1-hydroxyethyl) phosphonate, 2,2-dichlorovinyl dimethyl phosphate, and 1,2-dibromo-2,2-dichloroethyl dimethyl phosphate. Other toxicants are selected from the group consisting of organophosphorus toxicants, carbamates, inorganic toxicants, and insect growth regulators.

A toxicant may be in a powdered form, may be a vapor released from a dispenser or may be incorporated into a bait whereby the moth becomes attracted to the toxicant and becomes contaminated or infected (in the case of pathogens) with the toxicant or ingests the toxicant. Toxicants which may be useful in this invention are those which will not adversely affect the attractiveness of the attractants of the invention. A variety of matrix materials may also be employed as a carrier for the toxicant and the attractant.

Combination of attractant and visual target. For purposes of trapping or baiting, visual targets may be used to focus close range orientation of attracted moths, either to facilitate their being captured in traps or to facilitate their arrival on a bait. For example, some species of moths are optimally attracted to bright white targets and others to small dark targets.

Kits and packaged attractants. The invention is also directed to kits. In one aspect the kit includes a trap and a lure for use within the trap and which provides the attractant. The kit may also include a drowning solution for some trap designs. Another kit includes at least two compounds, wherein one compound is β-myrcene and another compound is one or more compounds selected from the group consisting of phenylacetaldehyde and benzyl acetate. Another kit includes at least two compounds, wherein one compound is phenylacetaldehyde and another compound is methyl-2-methoxybenzoate. The ingredients may be in a drowning solution, formulation (chemical matrix to hold and release one or more attractant chemicals), dispenser or bait as discussed above. Drowning solutions, formulations, dispensers and controlled release devices may be rechargeable with a measured amount of the attractant ingredients.

A bait kit may contain the compounds to provide the attractant component, combination or blend of the invention in a matrix or suitable carrier for moths to contact and remove. The bait may also contain additives, such as feeding stimulants, toxicants, extenders, antioxidants, and/or UV adsorbers.

The invention is also directed to a packaged attractant which comprises at least two ingredients as described above, wherein the at least two ingredients are packaged in separate containers and wherein the packaged attractant further comprises instructions for producing a volatilized blend.

### EXAMPLES

The following examples are intended only to further illustrate the invention and are not intended to limit the scope of the invention which is defined by the claims. The compounds of the chemical attractants of the invention are all commercially available.

### Example 1

The following example describes our work on the characterization of the floral odor of Oregongrapee (Berberis aquifolium) as possible feeding attractants for moths. We collected and identified moths at flowers of Oregongrapee plants, and characterized the volatile chemicals emitted by those flowers.

Methods. Insect visitors to flowers of Oregongrapee plants were sampled using large white mesh cone shaped traps (Heliothis traps) placed directly above clusters of open flowers. Insects are trapped when they fly up from flowers into the cone of the trap and cannot escape the upper chamber. Traps were placed over flower clusters in late afternoon (1500 to 1600 hrs P.S.T.) and were checked the following morning (800 to 900 hrs P.S.T.) for insects. We sampled 37 times during April and May 2001: at the Yakima Agricultural Research Laboratory near Wapato (n=3), Randall Park in the city of Yakima (n=5), a residence in Yakima (n=4), Oak Creek Wildlife Preserve (n=9), Mud Lake (n=15) west of Yakima, and the Valley Mall in Union Gap (n=1). All trap sites were in Yakima County, Wash.

Volatiles emitted by flower clusters on Oregongrapee shrubs at the USDA-ARS Yakima Agricultural Research Laboratory were collected by a portable volatile collection system, which included an electric air suction pump, flow meter, a gas sampling bag, and a SuperQ trap. Air was pulled through a septum port in the 10 liter Tedlar gas sampling bag housing the flowers, through the flowmeter at a rate of 2-3 L of air per minute, and then through the trap in which odor chemicals were adsorbed. The bag was placed over a branch with flowers and was loosely tied off at the branch stem. Air was pulled through the volatile collection system for 1 hr, during late afternoon or early evening. The volatile collection trap contained 30 mg of SuperQ adsorbent in a 0.635 cm×6.67 cm long borosilicate glass tube. The trap was extracted with 600 μL of 10% ether in hexane. As a control, similar volatile collections were made over Oregongrapee plants that did not possess flowers. The open flowers within volatile collection bags were counted and recorded for computations of chemical amounts emitted per flower per unit time. This volatile collection procedure was followed five times for plants with flowers and nine times for plants without flowers. All collections were made over plants on the grounds of the USDA-ARS Yakima Agricultural Research Laboratory.

One-microliter aliquots of the extracts of SuperQ traps were analyzed by gas chromatography-mass spectrometry (GC-MS), using a Hewlett Packard 6890 Plus gas chromatograph with a model 5973 electron impact mass selective quadrapole detector. The gas chromatograph was equipped with an HP-1 MS fused silica capillary column (60 m long, 0.25 mm i.d., 25 μm film thickness) and then a DB Wax fused silica capillary column of the same dimensions. Analyses were run at an initial temperature of 40° C. for 2 min, increasing 15° C. per min to a maximum of 200° C. Mass spectra of eluting peaks were matched to those in the Wiley 275 and NIST98 libraries of compounds to obtain preliminary structural identifications. Structures were confirmed by comparing retention times of eluting peaks with known standards, using both types of GC columns, and by comparing mass spectra of eluting peaks and of known standards to those in the Wiley and NIST data bases.

Additional analyses were conducted to determine the enantiomeric makeup of α- and β-pinene and limonene. Commercial sources of compounds were used as standards that were compared with α-pinene, β-pinene, and limonene from Oregongrapee volatile collections. Two samples of Oregongrapee odorants (volatile collection trap extract) and standards for (R)- and (S)-α-pinene, (R)- and (S)-β-pinene, and (R)- and (S)-limonene were analyzed on a Hewlett Packard 5890 II Plus GC using a 0.25 mm×30 m Cyclosil B fused silica capillary column. Temperature program was 40° C. for 2 min, increasing 10° C. per min to a maximum of 180° C. Kovat's retention indices were calculated using a homologous series of hydrocarbons to bracket each compound (nonane through dodecane). One extract sample was spiked with the hydrocarbon series before analysis, while another sample was compared to the hydrocarbons in a parallel GC analysis. A sample of racemic α-pinene was also analyzed following the addition of the hydrocarbon series to the sample, for precise determination of retention indices of the two enantiomers and to verify that the two enantiomers were adequately separated using those methods.

Synthetic chemical standards used in establishing GC retention times and for comparing spectroscopic data were purchased from chemical supply companies. These were benzaldehyde, phenylacetaldehyde, β-myrcene, (S)-(−)-β-pinene, (R)-(+)-β-pinene, racemic α-pinene, (1R)-(+)-α-pinene, (R)-(+)- and (S)-(−)-limonene, sabinene, and (S)-(−)-α-pinene. Synthetic E-β-ocimene was not commercially available. A 93% pure sample of E-β-ocimene was then obtained by HPLC fractionation of pure essential oil of basil which possesses this compound (Özek et al. 1995, Fleisher and Fleisher 1992). The E-β-ocimene was isolated from basil oil using an Agilent 1100 series HPLC equipped with an Agilent Eclipse semi-prep column (#XDB-C18, 9.4 mm×250 mm). A standard flow cell was used with a column-switching valve for collection of fractions from elution with 50% acetonitrile: 50% water at 4 ml/min. Identification of a compound in basil oil as E-β-ocimene was verified by GC-MS analysis under the conditions indicated above.

Results. Ninety-two moths were captured in traps over Oregongrapee flowers, 41 males and 51 females (Table 1). Most moths captured were either alfalfa looper moths (42%), or the gooseberry fruitworm (Zophodia grossulariella) (26%). While both male and female alfalfa looper moths were captured, only female and no male gooseberry fruitworm moths were captured in the traps. Eleven other species of noctuid moths and three species of geometrid moths were captured. In addition, 125 honeybees (Apis mellifera), 137 queen bumblebees (Bombus sp.), 71 other unidentified bees, 23 queen German wasps (Vespula germanica), 3 female golden paper wasps (Polistes aurifer) and 152 unidentified flies were trapped.

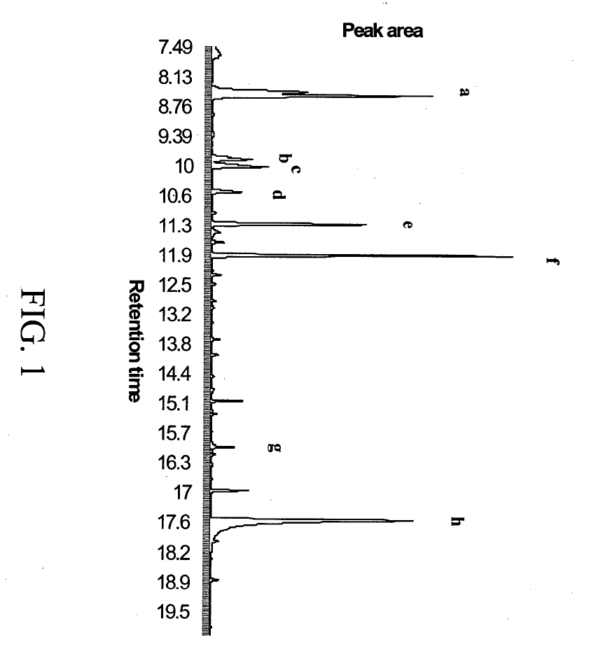

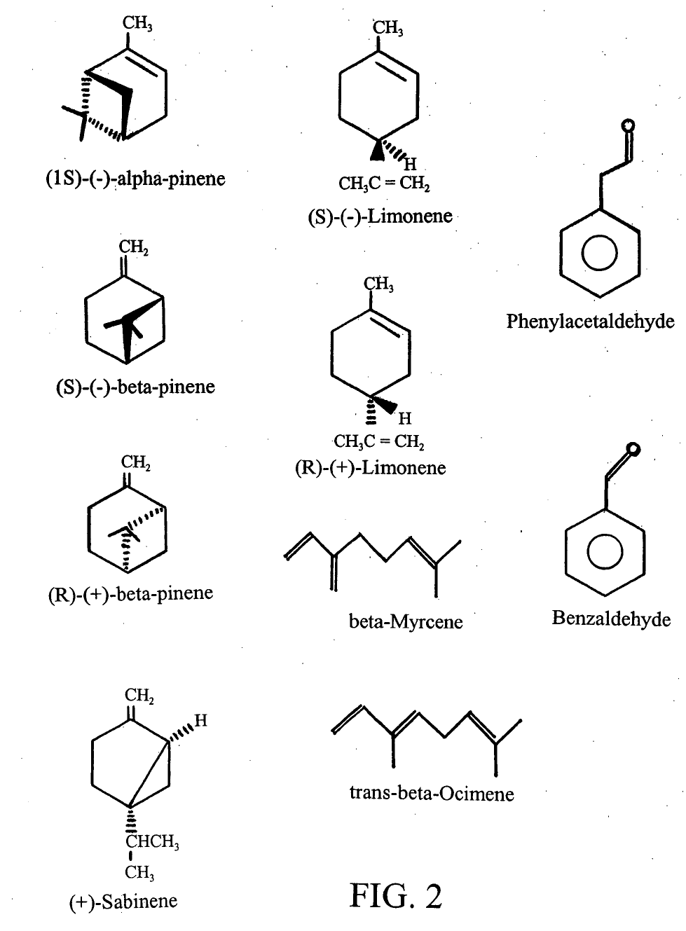

Eight compounds were present in chromatograms from all five air collections made over blossoms of Oregongrapee shrubs (FIGS. 1, 2). β-pinene and limonene were present in volatile collections as both enantiomeric forms (FIG. 2). These compounds were not detected in samples collected from nonflowering Oregongrapee shrubs. The limit of detection was estimated to be about 30 ng per collection, which is a limit of 0.05 ng as a GC peak, and with one μL of the 600 μL sample injected for analysis (0.05 ng/μl×600 μl/sample=30 ng/sample).

The largest amounts of chemicals collected were phenylacetaldehyde and (S)-(−)-α-pinene, followed by E-β-ocimene and limonene (Table 2). The amounts collected were also quite variable, as indicated by the standard errors of the means (Table 2), but the proportions were relatively stable, as is indicated by the smaller standard error values for mean percents of total emissions calculations (Table 2).

Results of this study show that several species of moths, bees, wasps, and flies, visit flowers of Oregongrapee and are potential pollinators. The most common moth visitor collected was the alfalfa looper moth. While both sexes of this moth were captured, the preponderance of alfalfa looper moths in traps were male. This species is generally abundant and flies from early spring into late autumn. Like the related cabbage looper and gamma moths, both male and female alfalfa looper moths visit flowers for nectar. The second most abundant moth collected was the gooseberry fruitworm moth. All collected specimens were collected were female, suggesting that the moth may respond to Oregongrapee flower chemicals in search of a place to oviposit, rather than in search of nectar on which to feed. However, this species is not known to infest fruits of Oregongrapee. The makeup of the species of moths collected is likely influenced by the early-season blooming of Oregongrapee in relation to the phenology of local moths, and by the regional moth community. Moths that emerge later in the season do not coincide with Oregongrapee blooming, and the species of moths visiting Oregongrapee flowers is probably somewhat different in other areas of the Pacific Northwest.

The odorous nature of Oregongrapee flowers suggests that volatile chemicals are released that might attract some species of moths. Comprehensive field-testing of these compounds, separately and in multi-component blends, as described in Examples 2 and 3, is required to determine any roles they may play in attracting moths or other potential pollinators to Oregongrapee flowers.

TABLE 1
Moths captured in traps over clusters of flowers of Oregongrape
shrubs. March-May 2001, Yakima County, Washington.

| Species | # Males | # Females |
|---|---|---|
| NOCTUIDAE | | |
| PLUSIINAE | | |
| Autographa californica | 26 | 13 |
| Trichoplusia ni | 1 | 0 |
| AMPHIPYRINAE | | |
| Apamea cariosa | 7 | 5 |
| Apamea cinefacta | 2 | 1 |
| Apamea spaldingi | 1 | 1 |
| HADENINAE | | |
| Discestra trifolii | 0 | 2 |
| Discestra mutata | 0 | 1 |
| Discestra oregonica | 1 | 0 |
| Dargida procincta | 1 | 0 |
| Leucania insueta | 0 | 1 |
| NOCTUINAE | | |
| Diarsia rosaria | 0 | 1 |
| Agrotis volubilis | 0 | 1 |
| GEOMETRIDAE | | |
| ENNOMIINAE | | |
| Digrammia californiaria | 1 | 0 |
| Synaxis cervinaria | 1 | 0 |
| Eupithecia sp. | 0 | 1 |
| PYRALIDAE | | |
| PHYCITINAE\ | | |
| Zophodia grossulariella | 0 | 24 |

TABLE 2
Mean (±SE) nanograms of compounds emitted per Oregongrape
flower per hour. N is the number of volatile collections from flowers
from which quantitative data were obtained. α-Pinene and
benzaldehyde co-eluted on two of five collections and were not
quantified in those samples.

| | | Percent of | |
|---|---|---|---|
| Chemical | Nanograms | Total Emission | N |
| Phenylacetaldehyde | 124.5 ± 40.8 | 32.9 ± 2.0 | 5 |
| α-Pinene | 87.6 ± 6.7 | 25.5 ± 6.4 | 3 |
| E-β-Ocimene | 54.4 ± 17.8 | 13.9 ± 2.8 | 5 |
| Limonene | 43.9 ± 7.0 | 12.5 ± 0.7 | 5 |
| Sabinene | 17.0 ± 2.7 | 4.9 ± 0.4 | 5 |
| Benzaldehyde | 14.5 ± 6.7 | 4.2 ± 6.7 | 3 |
| β-Pinene | 12.3 ± 2.0 | 3.6 ± 0.4 | 5 |
| β-Myrcene | 8.6 ± 2.1 | 2.4 ± 0.3 | 5 |

### Example 2

The following example describes the evaluation of six floral compounds, β-myrcene, α-pinene, β-pinene, limonene, methyl salicylate, and methyl-2-methoxybenzoate, alone and in various combinations, as attractants for alfalfa looper moths and cabbage looper moths.

Materials and Methods. A multi-colored version of the Universal Moth Trap, or UniTrap® (AgriSense, sold by Great Lakes IPM, Vestaburg, Mich.), was used in all experiments. The trap is an opaque white bucket beneath a yellow cone and a green lid. A 2.5×2.5 cm piece of Vaportape® (Hercon Environmental, Emigsville, Pa.) was placed in each trap bucket as a killing agent. Traps were hung from stakes at a height of about one meter in uncultivated areas adjacent to fields of alfalfa or directly within alfalfa fields. Traps were placed 12 meters apart in a north to south orientation, because of prevailing westerly winds.

For all experiments, a randomized complete block design was used, and treatments were randomized each time traps were checked. Traps were checked twice per week, at which time all insects in the traps were placed in pre-labeled plastic bags for transport to the laboratory. Moths were identified and sorted by sex under a dissecting microscope.

β-Pinene, (R)-(+)-α-pinene, (S)-(−)-limonene, β-myrcene, phenylacetaldehyde, methyl salicylate, and methyl-2-methoxybenzoate were purchased from Aldrich Chemical Co. (Milwaukee, Wis.). (R)-(+)-limonene was purchased from Acros Chemical Co. (Milwaukee, Wis.).

Polypropylene vials (8 ml) were used as dispensers for release of chemicals tested, following the methods used in Landolt et al., 2001, supra. Chemicals (5 ml) were pipetted onto cotton in the bottom of the vial. Holes made in vial lids (3 mm diameter) permitted the escape of volatilized chemicals. Vials were suspended with wire near the bottom of the inside of the bucket of the UniTrap®. When more than one chemical was used to bait a trap, a separate vial was used for each chemical. Dispensers were replaced after two weeks when experiments lasted longer than two weeks.

Single Component Floral Lures.

A comparison was made of moth captures in traps baited with seven different chemicals that are emitted by flowers. These chemicals were phenylacetaldehyde, (included as a positive control and standard for comparison), methyl salicylate, racemic limonene, methyl-2-methoxybenzoate, (R)-(+)-α-pinene, (S)-(−)-β-pinene, and β-myrcene. Five replicate blocks, each including these seven chemical treatments and an unbaited trap, were set up on 18 May 2001 and were maintained until 1 Jun. 2001. The study was conducted at an experimental farm about 20 km east of the town of Moxee, in Yakima County, Wash. The same study was conducted again 3-27 July 2001 near Mattawa, Grant County, Wash., in order to take advantage of cabbage looper populations that became apparent in mid summer.

Trap catch data were subjected to an ANOVA and treatment means were separated using Tukey's test, following a significant F value in the ANOVA.

Double Component Blends, PAA Plus

The compounds methyl salicylate, racemic limonene, methyl-2-methoxybenzoate, (R)-(+)-α-pinene, S-(−)-β-pinene, and β-myrcene were also tested in combination with phenylacetaldehyde (PAA) for evidence of improvement over moth attraction to phenylacetaldehyde alone. Phenylacetaldehyde was the strongest attractant for alfalfa loopers among chemicals tested previously (Landolt et al., 2001, supra) and is an attractant also for cabbage looper and soybean looper moths (Cantelo and Jacobson, 1979, supra; Haynes et al., 1991, supra; Landolt et al., 1991, supra; Heath et al., Environmental Entomology 21:854-859, 1992). For each of these two-chemical combinations, two vials were placed in the bucket of the trap; one vial containing phenylacetaldehyde and the other vial containing the second chemical. Phenylacetaldehyde alone was included in the experiment as a treatment for comparison (positive control). Five replicate blocks, each including the six different two-chemical combinations as well as phenylacetaldehyde, alone, were set up on 8 Jun. 2001 and were maintained until 22 Jun. 2001, near Mabton, Yakima County, Wash. This experiment was conducted again 2 July to 3 Aug. 2001 near Mattawa, Grant County, Wash.

Trap catch data were subjected to an ANOVA and treatment means were separated using Tukey's test, following a significant F value in the ANOVA.

2—Component Ratio Experiment

The purpose of this experiment was to obtain additional evidence that the selected floral chemicals enhance alfalfa looper moth response to phenylacetaldehyde. A series of ratios of co-attractants were then tested (methyl-2-methoxybenzoate, β-myrcene, linalool, and cis-jasmone) each in combination with phenylacetaldehyde. A range of ratios of the compounds was obtained by using six different hole diameters for the vial dispensers containing each co-attractant. Each treatment included a vial of phenylacetaldehyde with a 3 mm diameter hole and a vial of a co-attractant with a hole diameter of either 0, 0.5, 1.0, 1.5, 3.0, or 6.0 mm. For each of these experiments, five replicate blocks were established, each block possessing one of each of the six treatments. The cis-jasmone plus phenylacetaldehyde test was begun 15 May 2001, the linalool plus phenylacetaldehyde test 31 May 2001 and again 14 Aug. 2001, the β-myrcene plus phenylacetaldehyde test 31 Jul. 2001, and the methyl-2-methoxybenzoate plus phenylacetaldehyde test 7 Aug. 2001. Traps were maintained for two weeks, providing 20 data sets for each experiment.

β-Myrcene were selected for this experiment because it was co-attractive with phenylacetaldehyde for alfalfa looper moths in the 2-component test. Methyl-2-methoxybenzoate was reported to be a co-attractant for cabbage looper moths by Lopez et al., supra. Cis-jasmone is also a co-attractant with phenylacetaldehyde for alfalfa looper moths (Landolt et al., 2001, supra). We have discovered that linalool is a co-attractant with phenylacetaldehyde for cabbage looper moths.

Trap catch data were subjected to linear regression analyses to determine if there was a relationship between chemical release rate (vial hole size) for the second chemical of the blend and the numbers of moths captured in traps. For all ratio tests, two-component combinations were compared to phenylacetaldehyde alone using Students t-test, to determine if moth captures were enhanced by the presence of the second chemical. This analysis was conducted for each of the second-chemical vial hole sizes.

3—Component Lures (A).

Four different 3-component lures were evaluated for evidence of enhanced attractiveness over corresponding 2-component blends. These were 1) phenylacetaldehyde plus methyl-2-methoxybenzoate plus β-myrcene, 2) phenylacetaldehyde plus methyl-2-methoxybenzoate plus linalool, 3) phenylacetaldehyde plus β-myrcene plus linalool, and 4) methyl-2-methoxybenzoate plus β-myrcene plus linalool. These treatments were compared to 6 different 2-component blends. These 2-component blends were: 5) phenylacetaldehyde plus methyl-2-methoxybenzoate, 6) phenylacetaldehyde plus β-myrcene, 7) phenylacetaldehyde plus linalool, 8) methyl-2-methoxybenzoate plus β-myrcene, 9) methyl-2-methoxybenzoate plus linalool, and 10) β-myrcene plus linalool. Five replicate blocks were established, each block including one of each of the ten treatments. This experiment was begun 24 Aug. 2001 and was maintained for two weeks near Mattawa, Grant County, Wash., providing 20 data sets.

Trap catch data were subjected to an ANOVA and treatment means were separated using Tukey's test, following a significant F value in the ANOVA.

Triple Component Lures (B).

An additional experiment was set up to evaluate the combination of phenylacetaldehyde plus cis-jasmone plus β-myrcene. This combination was compared to the three corresponding 2-component blends of phenylacetaldehyde plus cis-jasmone, phenylacetaldehyde plus β-myrcene, and cis jasmone plus β-myrcene. These four treatments were compared in 5 replicate blocks, providing 20 data sets. The study was established 31 Aug. 2001, and were maintained for 2 weeks near Mattawa, Grant County, Wash.

Double Component Blends Benzyl Acetate Plus

The compounds methyl salicylate, racemic limonene, methyl-2-methoxybenzoate, (R)-(+)-α-pinene, (S)-(−)-β-pinene, and β-myrcene were tested in combination with benzyl acetate for evidence of improvement over moth attraction to benzyl acetate alone. Benzyl acetate was attractive to alfalfa loopers in previous tests (Landolt et al. 2001) and is an attractant also for cabbage looper moths (Haynes et al., 1991, supra; Landolt et al., 1991, supra; Heath et al., Environmental Entomology 21:854-859, 1992). For each of these two-chemical combinations, two vials were placed in the bucket of the trap; one vial containing benzyl acetate and the other vial containing the second chemical. Benzyl acetate alone and phenylacetaldehyde alone were included in the experiment as treatments for comparison (positive control). Five replicate blocks, each including the six different two-chemical combinations as well as benzyl acetate and phenylacetaldehyde, were set up on 12 Jul. 2002 and were maintained until 5 Aug. 2002, near Mabton, Yakima County, Wash.

Trap catch data were subjected to an ANOVA and treatment means were separated using an LSD test, following a significant F value in the ANOVA.

### Results

Single Component Experiment

Numbers of alfalfa looper moths captured in traps baited with phenylacetaldehyde or with β-myrcene were greater than in unbaited traps, indicating attraction of moths to these chemicals (Table 3). The numbers of alfalfa loopers captured in traps baited with phenylacetaldehyde were much greater than those captured in traps baited with β-myrcene. Significantly more cabbage looper moths were captured in traps baited with phenylacetaldehyde or with methyl-2-methoxybenzoate, compared to unbaited traps, indicating moth attraction to these two compounds. The numbers of cabbage looper moths captured in traps baited with phenylacetaldehyde were much greater than those captured in traps baited with methyl-2-methoxybenzoate. Totals of 125 male and 306 female alfalfa looper moths and 130 male and 192 female cabbage looper moths were captured in traps in this experiment.

Double Component Experiment: Phenylacetaldehyde Plus.

Numbers of alfalfa looper moths captured in traps baited with both phenylacetaldehyde and β-myrcene were significantly greater than numbers captured in traps baited with phenylacetaldehyde alone (Table 4). Alfalfa looper moths captured in traps baited with all other two component lures were similar to numbers captured with phenylacetaldehyde. Numbers of cabbage looper moths captured in traps baited with both phenylacetaldehyde and methyl-2-methyl salicylate were significantly greater than numbers captured in traps baited with phenylacetaldehyde alone (Table 4). Cabbage looper moths captured in traps baited with all other two component lures were not significantly greater than numbers captured with phenylacetaldehyde alone. Totals of 606 male and 1000 female alfalfa looper moths, and 986 male and 1132 female cabbage looper moths were captured in traps in this experiment.

Double Component Ratio Experiment.

There was not a significant relationship between the methyl-2-methoxybenzoate vial dispenser hole size and the numbers of alfalfa looper moths captured (r²=0.04, p=0.71, df=4), when the combination of methyl-2-methoxybenzoate and phenylacetaldehyde was used together to bait traps. Also, in pair-wise comparisons (t-test), numbers of alfalfa looper moths captured with phenylacetaldehyde and methyl-2-methoxybenzoate were not greater (p>0.05) than numbers captured with phenylacetaldehyde alone, for any of the methyl-2-methoxybenzoate vial hole sizes. There also was not a significant positive relationship between methyl-2-methoxybenzoate vial hole size and numbers of cabbage looper moths captured (r²=0.44, p=0.15, df=4), during this same experiment. However, numbers of cabbage looper moths were significantly greater in traps baited with both phenylacetaldehyde and methyl-2-methoxybenzoate compared to phenylacetaldehyde alone, where methyl-2-methoxybenzoate vials had holes of 1.5 mm (t=3.48, p=0.001, df=19), 3 mm (t=3.34, p=0.002, df=19), and 6 mm (t=4.51, p=0.0001, df=19). Totals of 226 male and 351 female alfalfa looper moths, and 1158 male and 1979 female cabbage looper moths were captured in traps in this experiment.

There was not a significant relationship between β-myrcene vial hole size and alfalfa loopers captured (r²=0.12, p=0.50, df=4). The numbers of alfalfa looper moths captured in traps baited with β-myrcene and phenylacetaldehyde together were significantly greater, however, than in traps baited with phenylacetaldehyde alone, for all β-myrcene vial hole diameters (for 0.5 mm holes t=5.76, p<0.001, df=19; for 1.0 mm holes t=4.57, p<0.001, df=19; for 1.5 mm holes t=6.13, p<0.001, df=19; for 3.0 mm holes t=5.51, p<0.001, df=19; for 6.0 mm holes t=5.16, p<0.001, df=19). There was not a significant relationship between the β-myrcene vial dispenser hole size and the numbers of cabbage looper moths captured (r²=0.08, p=0.59, df=4). Totals of 363 male and 443 female alfalfa looper moths, and 445 male and 918 female cabbage looper moths were captured in traps in this experiment.

There was not a significant relationship between the linalool vial dispenser hole size and the numbers of alfalfa looper moths captured, when the combination of linalool and phenylacetaldehyde was used to bait traps (r²=0.04, p=0.72, df=4). There was not a significant increase in alfalfa looper moths captured with phenylacetaldehyde and linalool, compared to phenylacetaldehyde alone, for all linalool vial hole sizes (p>0.05). There was a significant relationship between linalool vial hole size and cabbage loopers captured, during this same experiment (r²=0.95, p<0.001, df=4, Y=13.2+3.69X, where Y is the number of moths captured and X is the vial hole diameter). The numbers of cabbage looper moths captured in traps baited with linalool and phenylacetaldehyde were significantly greater, however, than in traps baited with phenylacetaldehyde alone, for all linalool vial hole diameters (for 0.5 mm holes t=1.85, p=0.04, df=19; for 1.0 mm holes t=1.81, p=0.04, df=19; for 1.5 mm holes t=3.29, p=0.002, df=19; for 3.0 mm holes t=2.58, p=0.009, df=19; for 6.0 mm holes t=5.50, p<0.001, df=19). Totals of 236 male and 331 female alfalfa looper moths, and 966 male and 1508 female cabbage looper moths were captured in traps in this experiment.

There was a significant relationship between the cis-jasmone vial dispenser hole size and the numbers of alfalfa looper moths captured, when the combination of cis-jasmone and phenylacetaldehyde was used to bait traps (r²=0.68, p=0.04, df=4, Y=2.93+0.25X, where Y is the numbers of moths captured and X is the vial hole diameter). Numbers of cabbage looper moths captured in this experiment were not suitable for statistical analysis. Totals of 155 male and 245 female alfalfa looper moths were captured in traps in this experiment.

3—Component Experiment (A)

For both alfalfa looper and cabbage looper moths, there were no 3-component blends that were more attractive than a corresponding 2-component blend (Table 5). For example, numbers of alfalfa looper moths in traps baited with the combination of phenylacetaldehyde plus β-myrcene plus methyl-2-methoxybenzoate were similar to numbers captured in traps baited with phenylacetaldehyde plus β-myrcene. Totals of 155 male and 326 female alfalfa looper moths, and 657 male and 1220 female cabbage looper moths were captured in traps in this experiment.

Triple Component Experiment B.

Numbers of alfalfa looper moths captured with the 3-component blend of phenylacetaldehyde, cis-jasmone, and β-myrcene were not significantly greater than with the combination of phenylacetaldehyde plus β-myrcene (Table 6). Numbers of cabbage looper moths captured with the 3-component blend were similar to numbers captured with either phenylacetaldehyde plus cis-jasmone or phenylacetaldehyde plus β-myrcene. Totals of 159 male and 221 female alfalfa looper moths, and 179 male and 331 female cabbage looper moths were captured in traps in this experiment.

Double Component Experiment: Benzyl Acetate Plus.

Significant numbers of alfalfa looper moths were captured in traps baited with benzyl acetate alone and with phenylacetaldehyde alone, compared to unbaited traps (Table 7). Greater numbers of alfalfa looper moths were captured in traps baited with the combinations of benzyl acetate and limonene and benzyl acetate and β-myrcene, compared to benzyl acetate alone (Table 7).

Discussion. This is the first demonstration of moth attraction to β-myrcene or methyl-2-methoxybenzoate. β-myrcene was also shown to increase catches of alfalfa looper moths when presented with phenylacetaldehyde or with benzyl acetate. In this study, it was also shown that methyl-2-methoxybenzoate and linalool both increased cabbage looper captures when presented with phenylacetaldehyde. None of the 3-component floral blends tested proved to be more attractive to alfalfa looper or cabbage looper moths than either the 2-component combination of phenylacetaldehyde and β-myrcene for alfalfa looper moths, or the 2-component combination of phenylacetaldehyde and methyl-2-methoxybenzoate for cabbage looper moths. Although there are numerous additional multi-component blends that might be tested, these results indicate that perhaps these moths are responding to limited subsets of the complex blends of odorants released by flowers.

These results demonstrate attraction of male and female alfalfa looper moths to feeding attractants that can be used as lures in traps. Numbers of both sexes captured in these tests indicate attraction by females to these lures that may be suitable for decreasing pest alfalfa looper populations through mass trapping or poison baiting.

TABLE 3
Mean (±SE) numbers of alfalfa looper moths and cabbage looper
moths captured in Universal moth traps baited with individual floral
chemicals dispensed from polypropylene vials.

| | Alfalfa | Cabbage |
|---|---|---|
| Chemical | looper moths | looper moths |
| control | 0.0 ± 0.0a | 0.0 ± 0.0a |
| phenylacetaldehyde | 4.5 ± 0.5c | 7.2 ± 1.0c |
| α-pinene | 0.0 ± 0.0a | 0.1 ± 0.0a |
| β-pinene | 0.0 ± 0.0a | 0.0 ± 0.0a |
| methyl salicylate | 0.1 ± 0.0a | 0.1 ± 0.1a |
| methyl-2-methoxybenzoate | 0.1 ± 0.0a | 0.6 ± 0.2b |
| β-myrcene | 0.4 ± 0.1b | 0.1 ± 0.1a |
| limonene | 0.0 ± 0.0a | 0.0 ± 0.0a |

Means within a column followed by the same letter are not significantly different by Tukey's test at P < 0.05.

TABLE 4
Mean (±SE) numbers of alfalfa looper moths and cabbage looper
moths captured in Universal moth traps baited with floral chemicals
dispensed from vials along with phenylacetaldehyde
(PAA) dispensed from vials.

| | Alfalfa | Cabbage |
|---|---|---|
| Chemical | looper moths | looper moths |
| unbaited | 0.00 ± 0.00a | 0.00 ± 0.00a |
| PAA | 1.40 ± 0.38b | 1.60 ± 1.36b |
| PAA plus α-pinene | 1.52 ± 0.44b | 1.80 ± 0.86b |
| PAA plus β-pinene | 1.72 ± 0.38b | 2.40 ± 1.47b |
| PAA plus methyl salicylate | 1.24 ± 0.42b | 4.40 ± 1.63c |
| PAA plus methyl-2-methoxybenzoate | 1.24 ± 0.38b | 1.40 ± 0.75b |
| PAA plus β-myrcene | 5.52 ± 1.31c | 3.40 ± 1.03bc |
| PAA plus limonene | 1.84 ± 0.60b | 2.00 ± 1.52b |

Means within a column followed by the same letter are not significantly different by Tukey's test at P < 0.05.

TABLE 5
Mean (±SE) numbers of alfalfa looper moths and cabbage looper
moths captured in Universal moth traps baited with floral chemicals
dispensed from vials. PAA is phenylacetaldehyde, MB is methyl-2-
methoxybenzoate, BM is β-myrcene, and LIN is linalool.

| | Alfalfa | Cabbage |
|---|---|---|
| Chemical | looper moths | looper moths |
| PAA-MB | 2.65 ± 0.97bc | 14.45 ± 3.37cd |
| PAA-BM | 6.65 ± 1.36d | 11.60 ± 2.18bc |
| PAA-LIN | 2.25 ± 0.45b | 13.25 ± 2.42bcd |
| MB-LIN | 0.30 ± 0.15a | 3.90 ± 1.55a |
| MB-BM | 0.20 ± 0.20a | 3.00 ± 0.83a |
| BM-LIN | 0.00 ± 0.00a | 2.85 ± 0.85a |
| PAA-MB-BM | 5.95 ± 1.00d | 13.10 ± 2.24bcd |
| PAA-MB-LIN | 2.75 ± 0.81bc | 14.80 ± 3.35d |
| PAA-BM-LIN | 3.30 ± 0.71c | 10.20 ± 2.55b |
| MB-BM-LIN | 0.15 ± 0.08a | 3.15 ± 0.92a |

Means within a column followed by the same letter are not significantly different by Tukey's test at P < 0.05.

TABLE 6
Mean (±SE) numbers of alfalfa looper moths and cabbage looper
moths captured in Universal moth traps baited with floral chemicals
dispensed from vials. PAA is phenylacetaldehyde, CJ is
cis-jasmone, and BM is β-myrcene.

| | Alfalfa | Cabbage |
|---|---|---|
| Chemical | looper moths | looper moths |
| PAA-CJ | 2.50 ± 0.65b | 8.20 ± 1.73b |
| PAA-BM | 7.65 ± 1.09c | 7.70 ± 1.50b |
| CJ-BM | 0.35 ± 0.25a | 1.15 ± 0.33a |
| PAA-CJ-BM | 8.55 ± 1.16c | 8.45 ± 1.21b |

Means within a column followed by the same letter are not significantly different by Tukey's test at P < 0.05.

TABLE 7
Mean (±SE) numbers of alfalfa looper moths captured in Universal
moth traps baited with floral chemicals dispensed from vials. BA is
benzyl acetate, PAA is phenylacetaldehyde, AP is alpha pinene, BP
is beta pinene, BM is β-myrcene, MS is methyl salicylate,
MMB is methyl-2-methoxybenzoate, and LIM is limonene.

| | Alfalfa |
|---|---|
| Chemical | looper moths |
| BA | 0.37 ± 0.12c |
| PAA | 0.83 ± 0.21e |
| BA/AP | 0.34 ± 0.11c |
| BA/BP | 0.29 ± 0.10bc |
| BA/BM | 0.91 ± 0.21e |
| BA/MS | 0.57 ± 0.24cd |
| BA/MMB | 0.49 ± 0.17cd |
| BA/LIM | 0.11 ± 0.07ab |
| CONTROL | 0.00 ± 0.00a |

Means within a column followed by the same letter are not significantly different by Tukey's test at P < 0.05.

### Example 3

The following example describes the evaluation of six floral compounds, β-myrcene, alpha-pinene, beta-pinene, limonene, methyl salicylate, and methyl-2-methoxybenzoate, alone and in various combinations, as attractants for corn earworm moths.

Materials and Methods. The Universal Moth Trap (Great Lakes IPM, Vestaburg, Mich.) was used in all tests, with a 6 cm² piece of Vaportape® (Hercon Environmental Inc., Emigsville, Pa.) in each trap bucket to kill captured moths. The trap is an opaque white bucket with a yellow cone and green lid. Traps were hung from stakes in the weedy borders around irrigated fields in the vicinity of sweet corn and alfalfa, near Mattawa, Grant County, Wash. Traps were placed 12 meters apart in a north to south orientation, because of prevailing westerly winds.

A randomized complete block design was used, and treatments (trap lures) were randomized each time that traps were checked. Traps were checked twice per week, and insects were placed in pre-labeled plastic bags for transport to the laboratory where they were stored in a freezer until processed. Moths were sorted by sex and identified to species with the aid of a dissecting microscope.

β-Pinene, R-(+)-alpha-pinene, (S)-(−)-limonene, β-myrcene, phenylacetaldehyde, methyl salicylate, and methyl-2-methoxybenzoate were purchased from Aldrich Chemical Inc. (Milwaukee, Wis.). (R)-(+)-limonene was purchased from Acros Chemical Co. (Milwaukee, Wis.).

Unless reported otherwise, polypropylene vials (8 ml) were used as dispensers for release of chemicals tested following the methods of Landolt et al., 2001, supra. Chemicals (5 ml) were pipetted onto cotton in the bottom of the vial. Holes made in the lids (3 mm diameter) permitted the escape of volatilized chemicals from the vials. Vials were suspended with wire near the bottom of the inside of the bucket of the trap. When more than one chemical was used to bait a trap, a separate vial was used for each chemical. Dispensers were replaced every 2 weeks when experiments lasted longer than two weeks.

Single Component Floral Lures A

During the 2000 field season, seven floral compounds were evaluated for attractiveness to corn earworm moths, testing them as lures in traps. These compounds were phenylacetaldehyde, benzyl alcohol, benzyl aldehyde, benzyl acetate, cis jasmone, linalool and phenethyl alcohol. A randomized complete block design was used, with 5 replicate blocks set up. Each block included an unbaited trap as a control.

A second comparison of floral compounds was made in the 2001 field season, for attractiveness to corn earworm moths. These chemicals were phenylacetaldehyde, methyl salicylate, racemic limonene, methyl-2-methoxybenzoate, (R)-(−)-alpha pinene, (S)-beta pinene, and β-myrcene. Five replicate blocks, each including these seven chemical treatments and an unbaited trap as a control, were set up on 3 Jul. 2001 and were maintained until 27 Jul. 2001.

Double Component Blends

Seven double component tests were conducted. For each two-component combinations, two vials were placed in the bucket of the trap; one vial containing phenylacetaldehyde and the other vial containing the second chemical (excepting the use of septa as dispensers for the third double component test that involved terpenes. Five replicate blocks, each including one of each of the different two-chemical combinations as well as phenylacetaldehyde alone, were set up and were maintained for two weeks.

Test 1. Benzyl acetate, benzyl alcohol, benzyl aldehyde, cis-jasmone, linalool, and phenethyl alcohol were tested in combination with phenylacetaldehyde, for evidence of co-attractiveness of these compounds with phenylacetaldehyde.

Test 2. Methyl salicylate, racemic limonene, methyl-2-methoxybenzoate, (R)-(+)-alpha pinene, (S)-beta pinene, and β-myrcene were also tested in combination with phenylacetaldehyde for evidence of improvement over moth attraction to phenylacetaldehyde alone.

Test 3. E,E-alpha farnesene, ocimene, geraniol, humulene, and phyllandrene were tested in combination with phenylacetaldehyde for evidence of improvement in moth attraction to phenylacetaldehyde alone.

Test 4. Benzyl acetate, benzaldehyde, benzyl alcohol, phenethyl alcohol, linalool and phenylacetaldehyde were tested in combination with cis jasmone for evidence of co-attractiveness with cis jasmone, with cis jasmone alone as a control.

Test 5. Benzyl aldehyde, benzyl alcohol, phenethyl alcohol, and linalool were tested in combination with benzyl acetate, with benzyl acetate alone and phenylacetaldehyde alone for comparison.

Test 6. The combinations of benzaldehyde plus benzyl alcohol, phenethyl alcohol plus benzyl alcohol, and linalool plus benzyl alcohol were tested in comparison to benzyl alcohol alone and phenylacetaldehyde alone.

Test 7. The combinations of linalool plus benzyl aldehyde, phenethyl alcohol plus benzaldehyde, and phenethyl alcohol plus linalool were compared to phenylacetaldehyde alone, linalool alone, benzyl aldehyde alone and phenethyl alcohol alone.

3—Component Lures:

Four different 3-component lures were evaluated for evidence of enhanced attractiveness over corresponding 2-component blends. These were 1) phenylacetaldehyde plus methyl-2-methoxybenzoate plus β-myrcene, 2) phenylacetaldehyde plus methyl-2-methoxybenzoate plus linalool, 3) phenylacetaldehyde plus β-myrcene plus linalool, 4) methyl-2-methoxybenzoate plus β-myrcene plus linalool. These treatments were compared to 6 different 2 component blends. These 2 component blends were 5) phenylacetaldehyde plus methyl-2-methoxybenzoate, 6) phenylacetaldehyde plus β-myrcene, 7) phenylacetaldehyde plus linalool, 8) methyl-2-methoxybenzoate plus β-myrcene, 9) methyl-2-methoxybenzoate plus linalool, and 10) β-myrcene plus linalool. This treatment was begun 24 Aug. 2001 and was maintained for two weeks near Mattawa.

Trap catch data were subjected to an ANOVA and treatment means were separated using Tukey's test, following a significant F value in the ANOVA.

### Results

Single Component Experiment

In the first test of floral compounds, in 2000, significant numbers of corn earworm moths were captured in traps baited with phenylacetaldehyde, compared to unbaited traps (Table 8). In the second test of single floral compounds, in 2001, numbers of corn earworm moths captured in traps baited with phenylacetaldehyde or with methyl-2-methoxybenzoate were significantly greater than in unbaited traps (Table 8). The numbers of corn earworm moths captured in traps baited with phenylacetaldehyde were not significantly different than those in traps baited with methyl-2-methoxybenzoate.

Double Component Experiments.

Test 1. Numbers of corn earworm moths in traps were not significantly increased by the addition of any of the floral chemicals in this test, over the numbers of moths captured with phenylacetaldehyde alone (Table 9).

Test 2. Numbers of corn earworm moths in traps baited with phenylacetaldehyde and β-myrcene and in traps baited with phenylacetaldehyde and methyl-2-methoxybenzoate were significantly greater than in traps baited with phenylacetaldehyde alone (Table 9). Numbers of corn earworm moths in traps baited with phenylacetaldehyde plus methyl-2-methoxybenzoate were greater than in traps baited with phenylacetaldehyde plus β-myrcene (Table 9).

Test 3. Methyl salicylate, limonene, alpha pinene and beta pinene did not significantly increase moth response to phenylacetaldehyde (Table 10).

Test 4. Benzyl acetate, benzyl alcohol, benzaldehyde, phenethyl alcohol, and linalool, in combination with cis jasmone, did not result in greater numbers of corn earworm moths trapped, compared to cis jasmone. Numbers of corn earworm moths in traps baited with the combination of cis jasmone and phenylacetaldehyde were greater than in traps baited with cis jasmone alone (Table 11).

Test 5. Benzaldehyde, benzyl alcohol, phenethyl alcohol, and linalool, in combination with benzyl acetate, did not increase numbers of corn earworm moths trapped, over those trapped with benzyl acetate alone (Table 11).

Test 6. Benzaldehyde, phenethyl alcohol, and linalool, in combination with benzyl alcohol, did not increase the numbers of corn earworm moths trapped over benzyl alcohol alone (Table 12).

Test 7. Linalool and phenethyl alcohol, in combination with benzaldehyde, did not increase numbers of corn earworm moths trapped in comparison to benzaldehyde alone, and the combination of linalool and phenethyl alcohol did not attract more corn earworm moths than either linalool alone or phenethyl alcohol alone (Table 12).

Numbers of corn earworm moths in traps baited with E,E-alpha farnesene plus phenylacetaldehyde were greater than in traps baited with phenylacetaldehyde alone (Table 10). Ocimene, geraniol, humulene, and phyllandrene did not increase moth response to phenylacetaldehyde alone.

3 Component Experiment.

There were no 3-component lures tested that were more attractive than the combination of phenylacetaldehyde plus methyl-2-methoxybenzoate (Table 13).

Discussion. Phenylacetaldehyde and methyl-2-methoxybenzoate were shown to be attractive to corn earworm moths. Methyl-2-methoxybenzoate, α-myrcene, and E,E-alpha farnesene were co-attractive to corn earworm moths when presented in traps with phenylacetaldehyde. Since β-myrcene and E,E-alpha farnesene were not attractive when either was presented alone, they both do appear to enhance moth response to phenylacetaldehyde.

These results demonstrate male and female corn earworm response to several compounds present in the odor of flowers that are visited by moths, including corn earworm. Out of these chemicals tested, the combination of phenylacetaldehyde and methyl-2-methoxybenzoate was noteworthy in the numbers of corn earworm moths captured, compared to other blends. In results with alfalfa looper responses to these and other floral chemicals, the combination of phenylacetaldehyde and β-myrcene appeared to be superior compared to other blends, and the combination of phenylacetaldehyde and methyl salicylate was superior over other blends for capture of cabbage looper moths in traps. In a direct comparison of these blends throughout a full season as discussed in Example 4, below, these apparent preferences held true for all three species.

TABLE 8
Mean (±SE) numbers of corn earworm moths captured in
Universal Moth Traps baited with individual floral chemicals
dispensed from polypropylene vials.

| 2000 Chemical | Moths | 2001 Chemical | Moths |
|---|---|---|---|
| Control | 0.00 ± 0.00a | Control | 0.03 ± 0.03a |
| Phenylacetaldehyde | 0.45 ± 0.22b | Phenylacetaldehyde | 2.35 ± 0.62b |
| Benzyl alcohol | 0.15 ± 0.08a | Methyl salicylate | 0.10 ± 0.05a |
| Benzyl aldehyde | 0.05 ± 0.05a | Limonene | 0.05 ± 0.05a |
| Benzyl acetate | 0.00 ± 0.00 | Methyl-2- | 3.90 ± 1.69b |
| | | methoxybenzoate | |
| Cis-jasmone | 0.00 ± 0.00 | Alpha pinene | 0.08 ± 0.04a |
| Linalool | 0.00 ± 0.00 | Beta pinene | 0.03 ± 0.03a |
| Phenethyl alcohol | 0.00 ± 0.00 | B-myrcene | 0.20 ± 0.10a |

Means within a column followed by the same letter are not significantly different by Tukey's test at p < 0.05.

TABLE 9
Mean (±SE) numbers of corn earworm moths captured in Universal
Moth Traps baited with floral chemicals dispensed from vials
along with phenylacetaldehyde (PAA) dispensed from vials.

| Test 1 Chemical | # Moths | Test 2 Chemical | # Moths |
|---|---|---|---|
| Control (PAA | 0.35 ± 0.18a | Control (PAA | 4.47 ± 1.47a |
| alone) | | alone) | |
| Benzyl acetate | 0.40 ± 0.17ab | Methyl salicylate | 3.51 ± 0.90a |
| Benzyl aldehyde | 0.40 ± 0.21a | Limonene | 3.44 ± 1.02a |
| Benzyl alcohol | 0.55 ± 0.18ab | Methyl-2- | 12.38 ± 3.43c |
| | | methoxybenzoate | |
| Linalool | 0.45 ± 0.15ab | alpha pinene | 3.40 ± 0.91a |
| Cis-jasmone | 0.55 ± 0.18ab | beta pinene | 3.98 ± 1.12a |
| Phenethyl alcohol | 0.40 ± 0.15ab | β-myrcene | 8.31 ± 2.20b |

Means within a column followed by the same letter are not significantly different by Tukey's test at p < 0.05.

TABLE 10
Mean (±SE) numbers of corn earworm moths captured in Universal
Moth Traps baited with plant terpene chemicals dispensed from
rubber septa along with phenylacetaldehyde (PAA)
dispensed from vials.

| Test 3 Chemical | # Moths |
|---|---|
| Control (PAA alone) | 0.05 ± 0.05a |
| E,E-alpha farnesene | 0.35 ± 0.11b |
| Ocimene | 0.15 ± 0.08a |
| Geraniol | 0.20 ± 0.09a |
| Humulene | 0.15 ± 0.08a |
| Phyllandrene | 0.15 ± 0.08a |

Means within a column followed by the same letter are not significantly different by Tukey's test at p < 0.05.

TABLE 11
Mean (±SE) numbers of corn earworm moths captured in
Universal Moth Traps baited with floral chemicals dispensed
from vials along with cis jasmone (CJ, test 4) or benzyl
acetate (BZAC, test 5) dispensed from vials.

| Test 4 Chemical | # Moths | Test 5 Chemical | # Moths |
|---|---|---|---|
| Control (CJ alone) | 0.05 ± 0.05a | PAA alone | 2.55 ± 0.79c |
| Benzyl acetate | 0.05 ± 0.05a | Control (BZAC | 0.25 ± 0.12a |
| Benzyl aldehyde | 0.05 ± 0.05a | alone) | |
| Benzyl alcohol | 0.00 ± 0.00 | Benzyl aldehyde | 0.30 ± 0.13a |
| Phenethyl alcohol | 0.10 ± 0.07a | Benzyl alcohol | 0.60 ± 0.22ab |
| Linalool | 0.00 ± 0.00a | Phenethyl alcohol | 0.50 ± 0.15a |
| Phenylacetaldehyde | 0.80 ± 0.05b | Linalool | 0.45 ± 0.17b |

Means within a column followed by the same letter are not significantly different by Tukey's test at p < 0.05.

TABLE 12
Mean (±SE) numbers of corn earworm moths captured in
Universal Moth Traps baited with single and double component
combinations of floral chemicals dispensed from vials. BZOH is
benzyl alcohol, BZAL is benzyl aldehyde, PHEN is phenethyl
alcohol, LIN is linalool, PAA is phenylacetaldehyde.

| Test 6 Chemicals | # Moths | Test 7 Chemicals | # Moths |
|---|---|---|---|
| BZOH | 0.10 ± 0.07a | PAA | 1.75 ± 0.43c |
| BZOH + BZAL | 0.25 ± 0.10ab | LIN | 0.00 ± 0.00a |
| BZOH + PHEN | 0.40 ± 0.15ab | BZAL | 0.05 ± 0.05a |
| BZOH + LIN | 0.25 + 0.10ab | BZAL + LIN | 0.20 ± 0.09ab |
| PAA | 2.25 ± 0.35c | BZAL + PHEN | 0.15 ± 0.08a |
| | | PHEN | 0.05 ± 0.05a |
| | | LIN + PHEN | 0.05 ± 0.05a |

Means within a column followed by the same letter are not significantly different by Tukey's test at p < 0.05.

TABLE 13
Mean (±SE) numbers of corn earworm moths captured in Universal
moth traps baited with floral chemicals dispensed from polypropylene
vials. PAA is phenylacetaldehyde, M2MB is methyl-2-methoxybenzoate,
BM is β-myrcene, and LIN is linalool.

| Chemicals | # Corn earworm moths |
|---|---|
| PAA + M2MB | 0.30 ± 0.16ab |
| PAA + BM | 0.05 ± 0.05a |
| PAA + LIN | 0.00 ± 0.00a |
| M2MB + LIN | 0.05 ± 0.05a |
| M2MB + BM | 0.00 ± 0.00a |
| BM + LIN | 0.00 ± 0.00a |
| PAA + M2MB + BM | 0.35 ± 0.11b |
| PAA + M2MB + LIN | 0.65 ± 0.18b |
| PAA + BM + LIN | 0.10 ± 0.07a |
| M2MB + BM + LIN | 0.15 ± 0.08ab |

Means within a column followed by the same letter are not significantly different by Tukey's test at p < 0.05.

### Example 4

The following example describes seasonal monitoring of alfalfa looper and corn earworm (Lepidoptera: Noctuidae) with flower-based feeding attractants.

Traps baited with floral lures were maintained throughout the season in the Yakima Valley to document seasonal variation in alfalfa looper, Autographa californica Geyer, cabbage looper, Trichoplusia ni Hübner, and corn earworm Helicoverpa zea Boddie response to these feeding attractants, to compare responses of the three species to three different flower chemistry blends, and to compare feeding attractant response to pheromone response in the corn earworm.

Materials and Methods. In late March 2002, 4 UniTraps® were set up at each of four farm sites in the lower Yakima Valley, Yakima County, Wash. These traps were baited with the following lures: a floral lure releasing phenylacetaldehyde and β-myrcene, a floral lure releasing phenylacetaldehyde and methyl salicylate, a floral lure releasing phenylacetaldehyde and methyl-2-methoxybenzoate, and a pheromone lure for males of the corn earworm. All floral lures were dispensed from 8 ml polypropylene vials with a 3 mm diameter hole in the lid. Each chemical was loaded at 5 ml neat into a separate vial. For each floral lure, two polypropylene vials (for the two chemicals) were suspended by a string in the bucket of the UniTrap®. Commercial sex pheromone lures were purchased from Trece Inc. These lures (septa) were placed in screen baskets attached to the inside center of the trap lid. Each trap included a 6 cm² piece of Vaportape® within the trap bucket to kill captured moths. All floral lures were replaced every two weeks, while sex pheromone lures and Vaportape® were replaced monthly.

Traps were suspended from wooden stakes at a height of about one meter, along weedy strips outside of irrigated fields of corn. At each site, traps were in a north-south line with 25 meters between traps. Trap sites were 15 to 20 kilometers apart. Traps were serviced twice per week from early April into early November. Moths captured were transferred to pre-labeled Ziplock® plastic bags for transport to the laboratory for sorting and recording of data. In addition to alfalfa looper, cabbage looper, and corn earworm moths, numbers of false corn earworm moths, Heliothis phloxiphaga, were tallied. All moths were also sorted by sex.

Trap catch data were tallied as weekly totals for each species and each lure type. For comparisons of lure type, data for each species were subjected to an Analysis of Variance, followed by an LSD test to determine significant differences among treatment means.

### Results

Overview: Alfalfa looper moths were captured primarily in traps baited with phenylacetaldehyde and β-myrcene, while corn earworm moths were captured primarily in traps baited with phenylacetaldehyde and methyl-2-methoxybenzoate. Most of the few cabbage looper moths captured were in traps baited with phenylacetaldehyde and methyl salicylate. Traps baited with corn earworm pheromone captured many more male corn earworm moths compared to the floral lures, but floral lures captured roughly equal numbers of males and females.

Details. Alfalfa looper moths were captured in floral lure traps from the first week of April when traps were placed in the field, until mid October. Highest captures were in mid May, with 70 moths per trap using β-myrcene and phenylacetaldehyde. Totals of 555 males and 674 females were captured in traps baited with phenylacetaldehyde and β-myrcene. Corn earworm moths were captured in floral lure traps baited with phenylacetaldehyde and methyl-2-methoxybenzoate from late May into late October, with highest captures in August. Totals of 53 male and 48 female corn earworm moths were captured in traps baited with phenylacetaldehyde and methyl-2-methoxybenzoate.

Male corn earworm moths were captured in traps baited with sex pheromone from mid June to mid October. Highest captures of corn earworm moths in pheromone traps was in late August into early September, with up to 400 moths per trap per week. False corn earworm moths were captured in corn earworm pheromone traps from early May to early September. Highest numbers captured were over 5 per trap per week in July.

Alfalfa looper, cabbage looper and corn earworm moths were captured in traps baited with all 3 blends of floral chemicals. However, numbers of alfalfa looper moths in traps baited with phenylacetaldehyde and β-myrcene were significantly higher than in traps baited with the other lures. More cabbage looper moths were captured in traps baited with phenylacetaldehyde and methyl salicylate, but due to the small numbers, these were not significantly higher than cabbage loopers caught with other floral lure treatments. Corn earworm moths captured in traps baited with phenylacetaldehyde and methyl-2-methoxybenzoate were significantly greater than in traps baited with the other floral lures.

It is understood that the foregoing detailed description is given merely by way of illustration and that modification and variations may be made within, without departing from the spirit and scope of the invention. All publications and patents cited herein are hereby incorporated by reference in their entirety.

1. A composition for attracting noctuid moths and other lepidopteran species which comprises an attractant component which comprises (I) β-myrcene and (II) one or more compounds selected from the group consisting of phenylacetaldehyde and benzyl acetate, wherein said attractant component provides an effective moth attractant amount of a vapor blend of I and II.

2. The composition of claim 1 wherein said attractant component comprises β-myrene:phenylacetaldehyde (I:II) or β-myrcene:benzyl acetate (I:II) in a ratio range of I:II of about 0.1:1 to 1:0.1.

3. The composition of claim 1 wherein said attractant component comprises β-myrene:phenylacetaldehyde (I:II) or β-myrcene:benzyl acetate (I:II) in a ratio range of I:II of about 0.5:1 to 1:0.5.

4. The composition of claim 1 wherein said attractant component comprises β-myrene:phenylacetaldehyde (I:II) or β-myrcene:benzyl acetate (I:II) in a ratio range of I:II of about 1:1 to 1:3.

5. The composition of claim 1 in combination with a lepidopteran insect pheromone.

6. A lure for attracting noctuid moths and other lepidopteran species which comprises a dispenser means which provides a composition comprising an attractant component which comprises (I) β-myrcene and (II) one or more compounds selected from the group consisting of phenylacetaldehyde and benzyl acetate, wherein said attractant component provides an effective moth attractant amount of a vapor blend of I and II.

7. The lure of claim 6 wherein said dispenser means contains a mixture of I and II.

8. The lure of claim 6 wherein said dispenser means comprises a first dispenser which contains I and a second dispenser which contains II, wherein said first and second dispensers are in sufficient proximity effective to provide said effective moth attractant amount of said vapor blend of I and II.

9. The lure of claim 6 wherein said attractant component comprises β-myrene:phenylacetaldehyde (I:II) or β-myrcene:benzyl acetate (I:II) in a ratio range of I:II of about 0.1:1 to 1:0.1.

10. The lure of claim 6 wherein said attractant component comprises β-myrene:phenylacetaldehyde (I:II) or β-myrcene:benzyl acetate (I:II) in a ratio range of I:II of about 0.5:1 to 1:0.5.

11. The lure of claim 6 wherein said attractant component comprises β-myrene:phenylacetaldehyde (I:II) or β-myrcene:benzyl acetate (I:II) in a ratio range of I:II of about 1:1 to 1:3.

12. The lure of claim 6 which further includes a lepidopteran insect pheromone.

13. The lure of claim 6 which further includes a means for controlling said moths.

14. A trapping system for monitoring or controlling noctuid moths and other lepidopteran species which comprises the lure of claim 6 and a means for trapping moths, wherein said lure is located with said trapping means.

15. A method of attracting noctuid moths and other lepidopteran species comprising placing in an area where said moths are to be attracted, a dispenser means which provides an attractant component which comprises (I) β-myrcene and (II) one or more compounds selected from the group consisting of phenylacetaldehyde and benzyl acetate, wherein said attractant component provides an effective moth attractant amount of a vapor blend of I and II.

16. The method of claim 15 wherein said dispenser means contains a mixture of I and II.

17. The method of claim 15 wherein said dispenser means comprises a first dispenser which contains I and a second dispenser which contains II, wherein said first and second dispensers are in sufficient proximity effective to provide said effective moth attractant amount of said vapor blend of I and II.

18. The method of claim 15 which further includes a lepidopteran insect pheromone.

19. The method of claim 15 which further includes a means for controlling said moths.

20. The method of claim 15 wherein said dispenser means is located within a means for trapping said moths.

21. A composition for attracting noctuid moths and other lepidopteran species which comprises an attractant component which comprises phenylacetaldehyde and methyl-2-methoxybenzoate, wherein said attractant component provides an effective moth attractant amount of a vapor blend of phenylacetaldehyde and methyl-2-methoxybenzoate, and wherein the composition does not include methyl salicylate.

22. The composition of claim 21 wherein said attractant component comprises phenylacetaldehyde and methyl-2-methoxybenzoate in a ratio range of about 0.1:1 to 1:0.1.

23. The composition of claim 21 wherein said attractant component comprises phenylacetaldehyde and methyl-2-methoxybenzoate in a ratio range of about 0.5:1 to 1:0.5.

24. The composition of claim 21 wherein said attractant component comprises phenylacetaldehyde and methyl-2-methoxybenzoate in a ratio range of about 1:1 to 3:1.

25. The composition of claim 21 in combination with a lepidopteran insect pheromone.

26. A lure for attracting noctuid moths and other lepidopteran species which comprises a dispenser means which provides a composition comprising an attractant component which comprises phenylacetaldehyde and methyl-2-methoxybenzoate, wherein said attractant component provides an effective moth attractant amount of a vapor blend of phenylacetaldehyde and methyl-2-methoxybenzoate, and wherein the composition does not include methyl salicylate.

27. The lure of claim 26 wherein said dispenser means contains a mixture of phenylacetaldehyde and methyl-2-methoxybenzoate.

28. The lure of claim 26 wherein said dispenser means comprises a first dispenser which contains phenylacetaldehyde and a second dispenser which contains methyl-2-methoxybenzoate, wherein said first and second dispensers are in sufficient proximity effective to provide said effective moth attractant amount of said vapor blend of phenylacetaldehyde and methyl-2-methoxybenzoate.

29. The lure of claim 26 wherein said attractant component comprises phenylacetaldehyde and methyl-2-methoxybenzoate in a ratio range of about 0.1:1 to 1:0.1.

30. The lure of claim 26 which further includes a lepidopteran insect pheromone.

31. The lure of claim 26 which further includes a means for controlling said moths.

32. A trapping system for monitoring or controlling noctuid moths and other lepidopteran species which comprises the lure of claim 26 and a means for trapping moths, wherein said lure is located with said trapping means.

33. A method of attracting noctuid moths and other lepidopteran species comprising placing in an area where said moths are to be attracted, a dispenser means which provides a composition comprising an attractant component which comprises phenylacetaldehyde and methyl-2-methoxybenzoate, wherein said attractant component provides an effective moth attractant amount of a vapor blend of phenylacetaldehyde and methyl-2-methoxybenzoate, and wherein the composition does not include methyl salicylate.

34. The method of claim 33 wherein said dispenser means contains a mixture of phenylacetaldehyde and methyl-2-methoxybenzoate.

35. The method of claim 33 wherein said dispenser means comprises a first dispenser which contains phenylacetaldehyde and a second dispenser which contains methyl-2-methoxybenzoate, wherein said first and second dispensers are in sufficient proximity effective to provide said effective moth attractant amount of said vapor blend of phenylacetaldehyde and methyl-2-methoxybenzoate.

36. The method of claim 33 which further includes a lepidopteran insect pheromone.

37. The method of claim 33 which further includes a means for controlling said moths.
